(19) United States
(12) Patent Application Publication
(10) Pub. No.: US 2026/0091772 A1
(43) Pub. Date: Apr. 2, 2026

(54) METHODS AND SYSTEMS FOR REDUCING EMISSIONS OF A HYBRID VEHICLE

(71) Applicant: Ford Global Technologies, LLC, Dearborn, MI (US)

(72) Inventors: David Cox, London (GB); David Hesketh, Ingatestone (GB); Bastian Hartmann, Hürth (DE); Jan Linsel, Cologne (DE); Oliver Berkemeier, Bergisch Gladbach (DE)

(21) Appl. No.: 19/332,627

(22) Filed: Sep. 18, 2025

(30) Foreign Application Priority Data
Sep. 30, 2024 (DE) 102024128248.7

(51) Int. Cl. B60W 20/16; B60W 10/06; B60W 10/08; B60W 10/30

(52) U.S. Cl. CPC B60W 20/16; B60W 10/06; B60W 10/08; B60W 10/30; B60W 2510/244; B60W 2555/20; B60W 2710/0677

(57) ABSTRACT

Methods and systems are provided for a hybrid vehicle. In one example, a method includes in response to an engine soak time greater than a threshold soak time, determining a battery state of charge (SOC) and comparing the battery SOC to a threshold SOC, activating an electric exhaust gas heater (eEGH) in response to the battery SOC being greater than the threshold SOC, and starting an engine using a starter generator in response to an ambient temperature being greater than or equal to a threshold ambient temperature

### CROSS REFERENCE TO RELATED APPLICATION

The present application claims priority to German Patent Application No. 102024128248.7 filed on Sep. 30, 2024. The entire contents of the above-listed application is hereby incorporated by reference for all purposes.

### FIELD

The present description relates generally to reducing engine start emissions of a hybrid vehicle.

### BACKGROUND/SUMMARY

A hybrid electric vehicle (HEV) is understood to mean an electric vehicle that is driven by at least one electric motor and another energy converter and draws energy from both its electrical storage unit (traction battery) and an additional fuel that it carries. The other energy converter is an internal combustion engine, usually a gasoline or diesel engine.

Such a hybrid drive may reduce the exhaust emissions of the internal combustion engine.

There is therefore a demand to identify ways in which the exhaust emissions of such a hybrid electric vehicle can be further reduced.

The issues described above may be at least partially solved by a method for in response to an engine soak time greater than a threshold soak time, determining a battery state of charge (SOC) and comparing the battery SOC to a threshold SOC, activating an electric exhaust gas heater (eEGH) in response to the battery SOC being greater than the threshold SOC, and starting an engine using a starter generator in response to an ambient temperature being greater than or equal to a threshold ambient temperature.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic representation of components of a drive train of a hybrid electric vehicle.

FIG. 2 shows a schematic representation of further details of the control unit shown in FIG. 1.

FIG. 3 shows a schematic representation of a method sequence for operating the hybrid electric vehicle shown in FIG. 1.

FIG. 4 shows a schematic representation of an activation sequence diagram during operation of the hybrid electric vehicle shown in FIG. 1.

FIG. 5 shows an example of a hybrid vehicle.

FIG. 6 shows a method for operating an engine of the hybrid electric vehicle during a cold-start.

### DETAILED DESCRIPTION

The following description relates to systems and methods for operating a hybrid electric vehicle, the method including reading in a battery status value indicative of a status of a traction battery of the hybrid electric vehicle and comparing the battery status value with a battery status reference value, and activating an eEGH of the hybrid electric vehicle if the battery status value is greater than the battery status reference value. The method may further optionally include reading in a temperature value indicative of an ambient temperature of the hybrid electric vehicle and comparing the temperature value with a temperature reference value, and starting an internal combustion engine of the hybrid electric vehicle using a starter generator of the hybrid electric vehicle if the temperature value is greater than the temperature reference value, and/or starting an internal combustion engine of the hybrid electric vehicle using a starter motor of the hybrid electric vehicle if the temperature value is lower than the temperature reference value.

The two step combinations of reading in a battery status value and activating an eEGH of the hybrid electric vehicle as well as reading in a temperature value and starting an internal combustion engine of the hybrid electric vehicle using a starter generator or using a starter motor of the hybrid electric vehicle, can be carried out in any order.

An eEGH is understood to mean an electric exhaust gas heater (also known as an E-Cat), which comprises at least one electric heating element for heating up the exhaust gas stream of the internal combustion engine or of at least one catalytic converter of an exhaust gas aftertreatment device of the hybrid electric vehicle.

In other words, the eEGH performs preheating when the battery status allows this. If the battery status does not allow it, a warm start or a cold start is performed, depending on the ambient temperature.

Thus, by using an eEGH which is fed from the traction battery, the exhaust emissions can be reduced, in particular during the starting operation of such a hybrid electric vehicle, since by using the eEGH the at least one catalytic converter of the exhaust gas aftertreatment device of the hybrid electric vehicle reaches its minimum operating temperature faster.

The method further comprises reading in a stoppage time to record a cooling period duration, and performing a warm start of the internal combustion engine of the hybrid electric vehicle if the cooling period duration is longer than a reference duration.

In other words, if the internal combustion engine and also the exhaust gas aftertreatment device have not yet cooled down, a warm start is performed. In this case, therefore, use of the cEGH is not necessary. The traction battery can be protected and the vehicle can be started with reduced CO₂ emission.

According to a further embodiment, the battery status value is based on detection and evaluation of a state of charge and/or an aging state and/or a battery cell temperature and/or a state of health of the traction battery. For example, a battery management system (BMS) can determine and evaluate these values. The battery management system can weight these values and combine them into a single quantity, which is then compared to a predetermined threshold. If the threshold is exceeded, the traction battery has a battery status that allows preheating with the cEGH. This allows the battery status to be determined particularly precisely.

According to a further embodiment, when starting an internal combustion engine of the hybrid electric vehicle using the starter motor of the hybrid electric vehicle a cold start is performed. This protects the traction battery of the hybrid electric vehicle in cold ambient temperatures.

The disclosure also includes a computer program product and a control unit, and a hybrid electric vehicle having such a control unit.

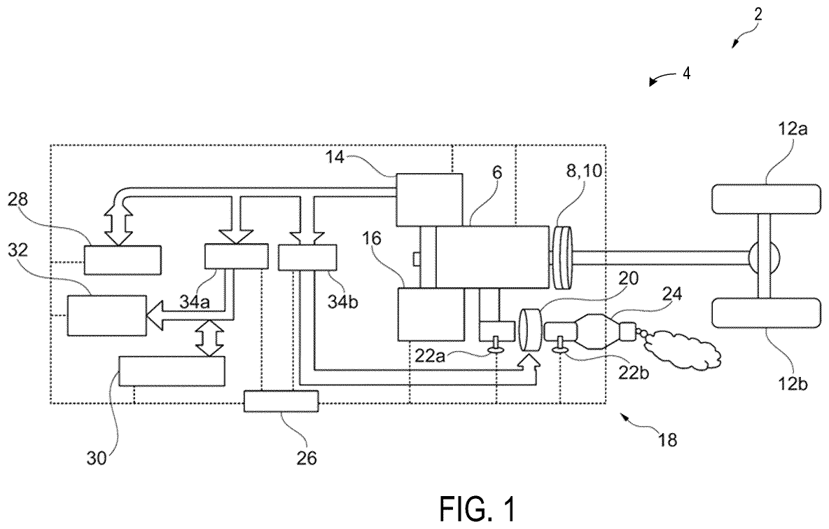

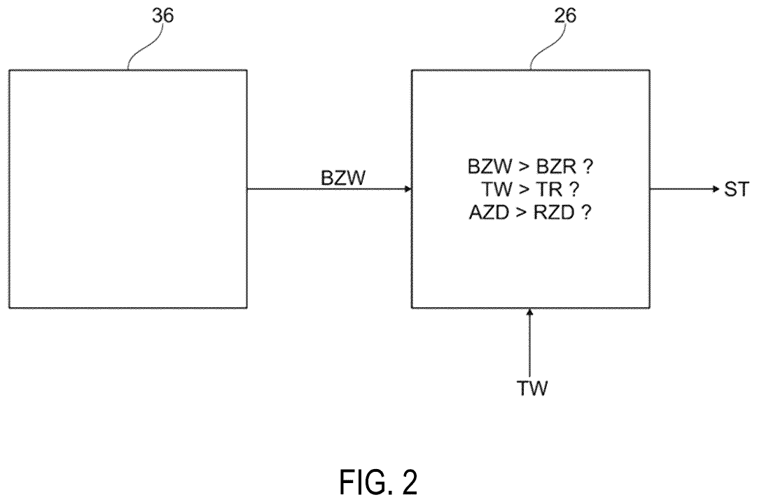

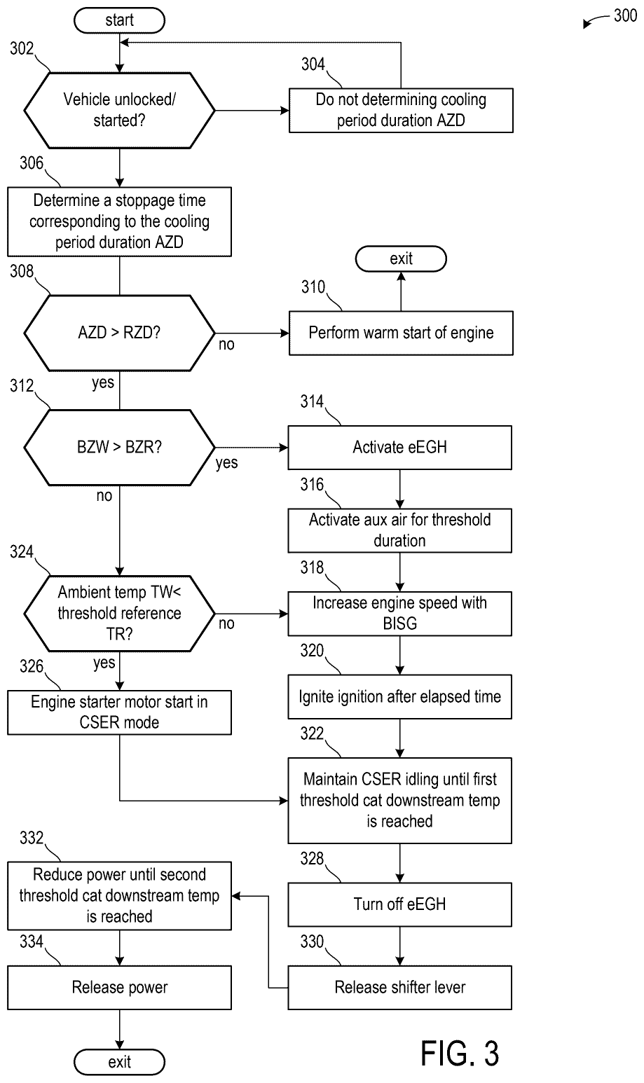

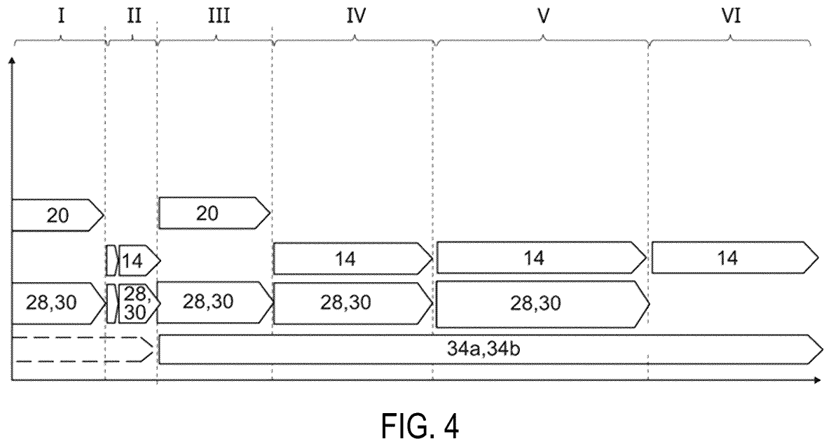

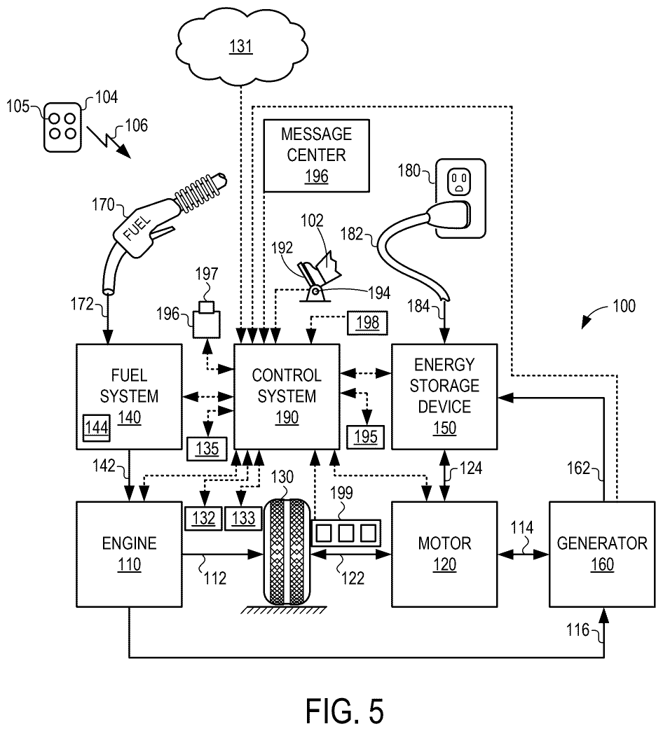

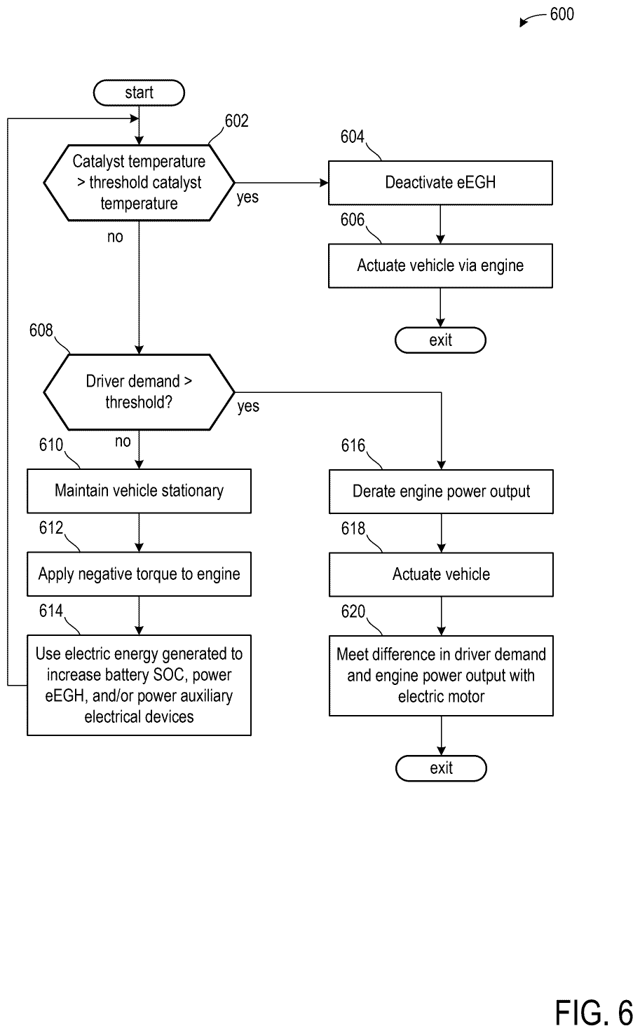

FIG. 1 shows a schematic representation of components of a drive train of a hybrid electric vehicle. FIG. 2 shows a schematic representation of further details of the control unit shown in FIG. 1. FIG. 3 shows a schematic representation of a method sequence for operating the hybrid electric vehicle shown in FIG. 1. FIG. 4 shows a schematic representation of an activation sequence diagram during operation of the hybrid electric vehicle shown in FIG. 1. FIG. 5 shows an example of a hybrid vehicle. FIG. 6 shows a method for operating an engine of the hybrid electric vehicle during a cold-start.

FIG. 1 shows example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

Turning now to FIG. 1, it shows components of a drive train 4 of a hybrid electric vehicle 2.

The hybrid electric vehicle 2 in the present exemplary embodiment is configured as a passenger car. Contrary to the present exemplary embodiment, the hybrid motor vehicle 2 may also be configured as a different type of road vehicle, such as a utility vehicle, e.g. a truck or a bus. Furthermore, in the present exemplary embodiment the hybrid electric vehicle 2 may be configured as a full-hybrid (FHEV), as a plug-in hybrid (PHEV) or a mild-hybrid.

Furthermore, in the present exemplary embodiment the hybrid electric vehicle 2 may be configured as a parallel hybrid or as a mixed hybrid.

In the present exemplary embodiment, the hybrid electric vehicle 2 is a parallel hybrid and a mild hybrid of category P0.

The drivetrain 4 of the hybrid electric vehicle 2 includes all components that generate the power for driving the hybrid electric vehicle 2 and transfer it to a road surface.

In the present exemplary embodiment, the components of the drive train 4 of an internal combustion engine 6, which is connected via a clutch 8 to a gearbox 10 in a torque-transmitting manner, are shown. In turn, two drive wheels 12a, 12b of the hybrid electric vehicle 2 are connected to the gearbox 10 in a torque-transmitting manner.

The internal combustion engine 6 in the present exemplary embodiment is a gasoline engine. Contrary to the present exemplary embodiment, it may also be a diesel engine.

Furthermore, in the present exemplary embodiment, a starter generator 14, in the present exemplary embodiment a chain or loop-driven integrated starter generator (BISG), is assigned to the drive train 4. Alternatively, the drivetrain 4 may also have a crankshaft-mounted integrated starter generator (C-ISG).

When the starter generator 14 is driven by the motor, to start or support the internal combustion engine 6, it is supplied with operating power from a traction battery 28, in the present exemplary embodiment a 48V battery. If, on the other hand, the starter generator 14 is operated in regenerative mode, it feeds recuperation energy, which may be generated during slowing operations, into the traction battery 28 via a DC/DC converter 34a into a battery bus 30 and a vehicle electrical system 32 of the hybrid electric vehicle 2.

In addition to the starter generator 14, in the present exemplary embodiment a starter motor 16 is connected to the internal combustion engine 6 and configured to transmit torque to the internal combustion engine 6, so that the internal combustion engine 6 may also be started using the starter motor 16. The starter motor 16 is supplied with operating energy from the traction battery 28.

Furthermore, in the present exemplary embodiment, an exhaust gas aftertreatment device 18 is provided for exhaust gas aftertreatment of exhaust gases of the internal combustion engine 6. For this purpose, the exhaust gas aftertreatment device 16 in the present exemplary embodiment comprises a catalytic converter 24, such as a diesel oxidation catalytic converter (DOC).

An cEGH 20 is connected upstream of the catalytic converter 24 in the exhaust flow direction. The cEGH 20 is an electric exhaust gas heater (also known as an E-Cat), which comprises at least one electric heating element for heating up the exhaust gas stream of the internal combustion engine 6 or the catalytic converter 24.

The eEGH 20 is supplied with operating energy from the traction battery 28 or from the regeneratively operated starter generator 14 via a DC/DC converter 34b.

Upstream and downstream of the eEGH 20, temperature sensors 22a, 22b are provided to detect the temperature of the exhaust gas stream before and after the cEGH 20. Upstream temperature sensor 22a may sense exhaust gas before the downstream temperature sensor 22b.

The temperature sensors 22a, 22b are connected for measurement data transfer to a control unit 26, which is connected to the said components so as to transmit control signals ST.

The control unit 26 and the components listed may have hardware and/or software components for the tasks and functions described in the following. In one example, the control unit 26 may be a controller with a memory arranged therein. The memory may include non-transitory memory with instructions stored thereon that when executed cause the controller to adjust operating parameters of the drivetrain 4.

Turning now to FIG. 2, it shows a more detailed view of the control unit 26. The control unit 26 is configured to read in a battery status value BZW indicative of a status of the traction battery 28 and to compare the battery status value BZW with a battery status reference value BZR. In one example, the battery status value BZW may correspond to a battery state of charge (SOC).

The battery status value BZW is determined by a battery management system 36. In the present exemplary embodiment, for this purpose the battery management system 36 detects and evaluates the SOC, an aging state, a battery cell temperature and a state of health of the traction battery 28. Contrary to the present exemplary embodiment, for example, only the state of charge may be detected and compared with a charge-state reference value of e.g. 75%.

Furthermore, the control unit 26 is configured to activate the eEGH 20 via a corresponding control signal ST when the battery status value BZW is greater than the battery status reference value BZR.

Furthermore, the control unit 26 is configured to read in a temperature value TW indicative of an ambient temperature of the hybrid electric vehicle 2 and to compare the temperature value TW with a temperature reference value TR, and to start the internal combustion engine 6 using the starter generator 14 via a further, corresponding control signal ST if the temperature value TW is greater than the temperature reference value TR. If, on the other hand, the temperature value TW is lower than the temperature reference value TR, the control unit 26 starts the internal combustion engine 6 using the starter motor 16 via a further corresponding control signal ST. In this case, in the present exemplary embodiment, a cold start (CSER) is effected by the control unit 26 via corresponding control signals.

Finally, in the present exemplary embodiment the control unit 26 is configured to track a stoppage time of the hybrid electric vehicle 2 in order to record a cooling period duration AZD and to perform a warm start of the internal combustion engine 6 if the cooling period duration AZD is longer than a reference duration RZD. In the present exemplary embodiment, the reference duration RZD is one hour. Thus, a timer is started at the time of the stoppage, i.e. when the engine is stopped, and the cooling period duration AZD is recorded. In contrast to or in addition to the present exemplary embodiment, it may also be provided, for example, to record an engine temperature and to compare it with a threshold value.

Turning now to FIG. 3, it shows a method 300 for operating the hybrid electric vehicle 2. Instructions for carrying out method may be executed by a controller based on instructions stored on a memory of the controller and in conjunction with signals received from sensors of the system, such as the sensors described above with reference to FIG. 1. The controller may employ actuators of the system to adjust operation, according to the method described below.

The method begins at 302, which includes determining is the hybrid electric vehicle 2 has been unlocked and/or a starter button of the hybrid electric vehicle 2 has been actuated by a driver.

If the hybrid electric vehicle 2 is not unlocked and/or the starter button of the hybrid electric vehicle 2 has not been actuated, then at 304, the method may include not determining cooling period duration AZD.

If the hybrid electric vehicle 2 is unlocked and/or the starter button of the hybrid electric vehicle 2 has been actuated by the driver, then at 306 the stoppage time is read in to determine the cooling period duration AZD.

At 308, the method may include determining if the cooling period duration AZD is less than a reference duration RZD, a warm start of the internal combustion engine 6 is executed at 310.

If the cooling period duration AZD is less than the reference duration RZD, then at 312, the method includes where the battery status value BZW, indicative of the status of the traction battery 28, is compared with the battery status reference value BZR.

If the battery status value BZW is greater than the battery status reference value BZR, the eEGH 20 of the hybrid electric vehicle 2 is activated at 314.

The method may proceed to 316, which includes activating auxiliary air for a threshold duration. In one example, the catalytic converter 24 is preheated via a fan which is activated for the threshold duration (e.g., 10 seconds).

The method 300 may proceed to 318, which includes increasing an engine speed with the BISG. The internal combustion engine 6 is started using the starter generator 14, e.g. with a speed of 2000 rpm.

At 320, the method may include igniting the engine following an elapsed time. In one example, the ignition is activated after 2 seconds.

At 322, the method may include maintain the CSER idling until a first threshold catalyst downstream temperature is reached. In one example, the internal combustion engine is operated at idle speed until the catalytic converter 24 has reached a temperature of e.g. 400° C.

Returning to 312, that the battery status value BZW is less than the battery status reference value BZR, then at 324, the method may include comparing the temperature value TW indicative of an ambient temperature is read in and compared with the temperature reference value TR.

If the temperature value TW is less than the threshold reference temperature TR, then the method proceeds to 318 as described above. If the temperature value TW is greater than the temperature reference value TR, then the method may proceed to 326, which includes where the internal combustion engine 6 is started using the starter generator 14.

If, on the other hand, the temperature value TW is lower than the temperature reference value TR, then the method proceeds to 326, which includes where the internal combustion engine 6 is started using the starter motor 16. Following 326, the method may proceed to 322 as described above.

At 328, the method may include where the eEGH 20 is switched off. In one example, the eEGH is turned off only if it is still activated after 10 seconds.

At 330, the method may include where a drive selector lever of the hybrid electric vehicle 2 is released so that the driver can set the hybrid electric vehicle 2 in motion.

At 332, the method may include where the power of the drive train 4 is reduced, in the present exemplary embodiment to 20 kW, until a predetermined catalytic converter temperature has been reached, in the present exemplary embodiment 600° C.

At 334, the method may include where the full power of the drive train 4 is enabled after a predetermined time period has elapsed, in the present exemplary embodiment 10 seconds.

The method may further optionally include where the traction battery 28 is charged by the regeneratively operated starter generator 14 until the traction battery 28 in the present exemplary embodiment has reached a predetermined state of charge of 75%.

Until the traction battery 28 in the present exemplary embodiment has reached the predetermined state of charge of 75%, the method may further include where motor-driven operation of the eEGH 20 is reduced or blocked, but it is only operated regeneratively.

Turning now to FIG. 4, it shows an exemplary drive cycle. During a first phase I, which represents a preheating phase, with the internal combustion engine 6 inactive, the catalytic converter 24 is preheated using the eEGH 20 and via a fan activated for 10 seconds in the present exemplary embodiment. The demanded operating power for the eEGH 20 and the fan is extracted from the traction battery 28.

In a second phase II, which represents a starting phase and which in the present exemplary embodiment is 3 seconds long, the starter generator 14 starts the internal combustion engine 6, e.g. with a speed of 1500 rpm. During this phase II, the eEGH 20 is inactive to protect the traction battery 28.

In a third phase III, which is a stationary heating phase, the eEGH 20 is reactivated and the operating power is again extracted from the traction battery 28.

In a fourth phase IV, which is a driving phase and in the present exemplary embodiment is 17 seconds long, the eEGH 20 supports the internal combustion engine 6. The operating energy is again extracted from the traction battery 28.

In a fifth phase V, which is a recuperation phase and in the present exemplary embodiment is 300 seconds long, the eEGH 20 is now no longer driven by the motor, but is operated regeneratively. The traction battery 28 is thus charged by the cEGH 20.

In a sixth phase VI, which is a combustion phase and in the present exemplary embodiment is indefinitely long, motor-driven operation of the eEGH 20 is suppressed, it is only operated regeneratively.

In an additional example, the order of the steps may also be different. In addition, a plurality of steps can also be executed at once or simultaneously. Furthermore, in another deviation from the present exemplary embodiment, individual steps can be skipped or omitted.

Thus, by using an eEGH 20 which is fed from the traction battery 28, the exhaust emissions can be reduced, in particular during the starting operation of such a hybrid electric vehicle 2, since by using the eEGH 20 the at least one catalytic converter 24 of the exhaust gas aftertreatment device 18 of the hybrid electric vehicle 2 reaches its minimum operating temperature faster. FIG. 5 illustrates an example vehicle propulsion system 100. Vehicle propulsion system 100 includes a fuel burning engine 110 and a motor 120. As a non-limiting example, engine 110 comprises an internal combustion engine and motor 120 comprises an electric motor 120. Motor 120 may be configured to utilize or consume a different energy source than engine 110. For example, engine 110 may consume a liquid fuel (e.g., gasoline) to produce an engine output while motor 120 may consume electrical energy to produce a motor output. As such, a vehicle with propulsion system 100 may be referred to as a hybrid electric vehicle (HEV). The vehicle propulsion system 100 may be a non-limiting example of the hybrid electric vehicle 2 of FIG. 1.

Vehicle propulsion system 100 may utilize a variety of different operational modes depending on operating conditions encountered by the vehicle propulsion system. Some of these modes may enable engine 110 to be maintained in an off state (e.g., set to a deactivated state) where combustion of fuel at the engine is discontinued. For example, under select operating conditions, motor 120 may propel the vehicle via drive wheel 130 as indicated by arrow 122 while engine 110 is deactivated.

During other operating conditions, engine 110 may be set to a deactivated state (as described above) while motor 120 may be operated to charge energy storage device 150. For example, motor 120 may receive wheel torque from drive wheel 130 as indicated by arrow 122 where the motor may convert the kinetic energy of the vehicle to electrical energy for storage at energy storage device 150 as indicated by arrow 124. Thus, motor 120 can provide a generator function in some examples. However, in other examples, generator 160 may instead receive wheel torque from drive wheel 130, where the generator may convert the kinetic energy of the vehicle to electrical energy for storage at energy storage device 150 as indicated by arrow 162.

During still other operating conditions, engine 110 may be operated by combusting fuel received from fuel system 140 as indicated by arrow 142. For example, engine 110 may be operated to propel the vehicle via drive wheel 130 as indicated by arrow 112 while motor 120 is deactivated. During other operating conditions, both engine 110 and motor 120 may each be operated to propel the vehicle via drive wheel 130 as indicated by arrows 112 and 122, respectively. A configuration where both the engine and the motor may selectively propel the vehicle may be referred to as a parallel type vehicle propulsion system. Note that in some examples, motor 120 may propel the vehicle via a first set of drive wheels and engine 110 may propel the vehicle via a second set of drive wheels.

In other examples, vehicle propulsion system 100 may be configured as a series type vehicle propulsion system, whereby the engine does not directly propel the drive wheels. Rather, engine 110 may be operated to power motor 120, which may in turn propel the vehicle via drive wheel 130 as indicated by arrow 122. For example, during select operating conditions, engine 110 may drive generator 160 as indicated by arrow 116, which may in turn supply electrical energy to one or more of motor 120 as indicated by arrow 114 or energy storage device 150 as indicated by arrow 162. As another example, engine 110 may be operated to drive motor 120 which may in turn provide a generator function to convert the engine output to electrical energy, where the electrical energy may be stored at energy storage device 150 for later use by the motor 120.

Fuel system 140 may include one or more fuel storage tanks 144 for storing fuel on-board the vehicle. For example, fuel tank 144 may store one or more liquid fuels, including but not limited to: gasoline, diesel, and alcohol fuels. In some examples, the fuel may be stored on-board the vehicle as a blend of two or more different fuels. For example, fuel tank 144 may be configured to store a blend of gasoline and ethanol (e.g., E10, E85, etc.) or a blend of gasoline and methanol (e.g., M10, M85, etc.), whereby these fuels or fuel blends may be delivered to engine 110 as indicated by arrow 142. Still other suitable fuels or fuel blends may be supplied to engine 110, where they may be combusted at the engine to produce an engine output. The engine output may be utilized to propel the vehicle as indicated by arrow 112 or to recharge energy storage device 150 via motor 120 or generator 160.

In some examples, energy storage device 150 may be configured to store electrical energy that may be supplied to other electrical loads residing on-board the vehicle (other than the motor), including cabin heating and air conditioning, engine starting, headlights, cabin audio and video systems, etc. As a non-limiting example, energy storage device 150 may include one or more batteries and/or capacitors.

Control system 190 may communicate with one or more of engine 110, motor 120, fuel system 140, energy storage device 150, and generator 160. Control system 190 may receive sensory feedback information from one or more of engine 110, motor 120, fuel system 140, energy storage device 150, and generator 160. Further, control system 190 may send control signals to one or more of engine 110, motor 120, fuel system 140, energy storage device 150, and generator 160 responsive to this sensory feedback. Control system 190 may receive an indication of an operator requested output of the vehicle propulsion system from a vehicle operator 102. For example, control system 190 may receive sensory feedback from pedal position sensor 194 which communicates with pedal 192. Pedal 192 may refer schematically to a friction pedal and/or a foot propulsion pedal. Furthermore, in some examples control system 190 may be in communication with a remote engine start receiver 195 (or transceiver) that receives wireless signals 106 from a key fob 104 having a remote start button 105. In other examples, a remote engine start may be initiated via a cellular telephone, or smartphone based system where a user's cellular telephone sends data to a server and the server communicates with the vehicle to start the engine.

Energy storage device 150 may periodically receive electrical energy from a power source 180 residing external to the vehicle (e.g., not part of the vehicle) as indicated by arrow 184. As a non-limiting example, vehicle propulsion system 100 may be configured as a plug-in hybrid electric vehicle (PHEV), whereby electrical energy may be supplied to energy storage device 150 from power source 180 via an electrical energy transmission cable 182. During a recharging operation of energy storage device 150 from power source 180, electrical transmission cable 182 may electrically couple energy storage device 150 and power source 180. While the vehicle propulsion system is operated to propel the vehicle, electrical transmission cable 182 may be disconnected between power source 180 and energy storage device 150. Control system 190 may identify and/or control the amount of electrical energy stored at the energy storage device, which may be referred to as the state of charge (SOC).

In other examples, electrical transmission cable 182 may be omitted, where electrical energy may be received wirelessly at energy storage device 150 from power source 180. For example, energy storage device 150 may receive electrical energy from power source 180 via one or more of electromagnetic induction, radio waves, and electromagnetic resonance. As such, it should be appreciated that any suitable approach may be used for recharging energy storage device 150 from a power source that does not comprise part of the vehicle. In this way, motor 120 may propel the vehicle by utilizing an energy source other than the fuel utilized by engine 110.

Fuel system 140 may periodically receive fuel from a fuel source residing external to the vehicle. As a non-limiting example, vehicle propulsion system 100 may be refueled by receiving fuel via a fuel dispensing device 170 as indicated by arrow 172. In some examples, fuel tank 144 may be configured to store the fuel received from fuel dispensing device 170 until it is supplied to engine 110 for combustion. In some examples, control system 190 may receive an indication of the level of fuel stored at fuel tank 144 via a fuel level sensor. The level of fuel stored at fuel tank 144 (e.g., as identified by the fuel level sensor) may be communicated to the vehicle operator, for example, via a fuel gauge or indication in a vehicle instrument panel 196.

The vehicle propulsion system 100 may also include an ambient temperature/humidity sensor 198, and a stability control sensor, such as a lateral and/or longitudinal and/or yaw rate sensor(s) 199. The vehicle instrument panel 196 may include indicator light(s) and/or a text-based display in which messages are displayed to an operator. The vehicle instrument panel 196 may also include various input portions for receiving an operator input, such as buttons, touch screens, voice input/recognition, etc. For example, the vehicle instrument panel 196 may include a refueling button 197 which may be automatically actuated or pressed by a vehicle operator to initiate refueling. For example, in response to the vehicle operator actuating refueling button 197, a fuel tank in the vehicle may be depressurized so that refueling may be performed.

In some examples, vehicle propulsion system 100 may include one or more onboard cameras 135. Onboard cameras 135 may communicate photos and/or video images to control system 190, for example. Onboard cameras may in some examples be utilized to record images within a predetermined radius of the vehicle, for example.

Vehicle system 100 may also include an on-board navigation system 132 (for example, a Global Positioning System) with which an operator of the vehicle may interact. The navigation system 132 may include one or more location sensors for assisting in estimating vehicle speed, vehicle altitude, vehicle position/location, etc. This information may be used to infer engine operating parameters, such as local barometric pressure. As discussed above, control system 190 may further be configured to receive information via the internet or other communication networks. Information received from the GPS may be cross-referenced to information available via the internet to determine local weather conditions, etc. In some examples, vehicle system 100 may include lasers, radar, sonar, acoustic sensors 133, which may enable vehicle location, traffic information, etc., to be collected via the vehicle.

The vehicle system 100 may be in wireless communication with a wireless network 131. The control system 190 may communicate with the wireless network 131 via a modem, a router, a radio signal, or the like. Data regarding various vehicle system conditions may be communicated between the control system 190 and the wireless network. Additionally, or alternatively, the wireless network 131 may communicate conditions of other vehicles to the control system 190.

Turning now to FIG. 6 it shows a method 600 for operating the vehicle during a cold-start. In one example, the method 600 may begin following a spin-up of the engine via the BISG or the starter motor. The method 600 may be executed via the controller of FIG. 1 and/or FIG. 5.

The method 600 begins at 602, which includes determining if the catalyst temperature is greater than a threshold catalyst temperature. The threshold catalyst temperature may be based on a non-zero positive number. In one example, the threshold catalyst temperature is based on a desired operating temperature of the catalyst to treat engine emissions to a target level. The catalyst temperature may be determined based on feedback from the upstream temperature sensor, the downstream temperature sensor, or both the upstream and downstream temperature sensors.

If the catalyst temperature is greater than the threshold catalyst temperature, then at 604, the method 600 may include deactivating the cEGH. As such, the eEGH does not consume electrical energy and heat the aftertreatment device.

At 606, the method 600 may include actuating the vehicle via the engine. In one example, at least a portion of driver demand is met via the engine and a remaining portion is met via the electric motor. In some example, the engine may meet all of the driver demand.

If the catalyst temperature is not greater than the threshold catalyst temperature, then at 608, the method 600 may include determining if driver demand is greater than a threshold driver demand. In one example, the threshold driver demand is based on a non-zero, positive number. In another example, the threshold driver demand may be based on a driver demand that includes actuation of the vehicle (e.g., movement of the vehicle out of a stationary position). In some examples, additionally or alternatively, the vehicle operator may receive a prompt indicating that a cold-start is occurring and it is desired to maintain the vehicle stationary until the catalyst temperature is greater than the threshold catalyst temperature.

If the vehicle operator follows the message and the driver demand is not greater than the threshold driver demand, then at 610, the method 600 may include maintaining the vehicle stationary. As such, engine torque is not used to move the vehicle.

At 612, the method 600 may optionally include applying a negative torque to the engine. The negative torque may include generating electricity via the engine. The electricity generated may be proportional to a difference between the engine power output and the driver demand.

At 614, the method 600 may include using the electricity generated by the engine to one or more of increase a battery SOC, power the eEGH, and power auxiliary electronic devices (e.g., vehicle cabin interior heater, heated surfaces, and the like). The method may continue to monitor the catalyst temperature and the driver demand until one or more of the catalyst exceeds the threshold catalyst temperature and the driver demand exceeding the threshold driver demand.

Returning to 608, if the driver demand is greater than the threshold driver demand such that the vehicle operator requests movement of the vehicle, then at 616, the method 600 may include derating the engine power output. Derating the engine power output may include limiting certain levels of engine power output above a threshold power output to limit emissions.

At 618, the method 600 may include actuating the vehicle. As such, the vehicle may be moved out of a stationary position.

At 620, the method 600 may optionally include meeting the difference between the derated engine power output and the driver demand with the electric motor. In one example, the electric motor operation may be controlled based on the battery SOC and the heating demands of the catalyst via the cEGH.

The disclosure also provides support for a method including in response to an engine soak time greater than a threshold soak time, determining a battery state of charge (SOC) and comparing the battery SOC to a threshold SOC, activating an electric exhaust gas heater (cEGH) in response to the battery SOC being greater than the threshold SOC, and starting an engine using a starter generator in response to an ambient temperature being greater than or equal to a threshold ambient temperature. In a first example of the method, the method further comprises: starting the engine using a starter motor in response to the ambient temperature being less than the threshold temperature. In a second example of the method, optionally including the first example, the method further comprises: activating an auxiliary fan for a threshold duration prior to starting the engine. In a third example of the method, optionally including one or both of the first and second examples, the method further comprises: applying a negative torque to the engine while a vehicle is stationary. In a fourth example of the method, optionally including one or more or each of the first through third examples, the method further comprises: utilizing electric energy generated while the vehicle is stationary to operate the eEGH or to increase the battery SOC. In a fifth example of the method, optionally including one or more or each of the first through fourth examples, the method further comprises: utilizing electric energy generate while the vehicle is stationary to operate auxiliary electric loads of the vehicle. In a sixth example of the method, optionally including one or more or each of the first through fifth examples, the starter generator increases an engine speed to a threshold engine speed. In a seventh example of the method, optionally including one or more or each of the first through sixth examples, the method further includes derating a power output of the engine relative to a driver demand and meeting a difference between the driver demand and the derated power output via an electric motor.

The disclosure also provides support for a system including an engine, an integrated started generator (BISG) coupled to the engine, a starter motor coupled to the engine, a battery configured to power each of the BISG and the starter motor, and a controller with computer-readable instructions stored on non-transitory memory that when executed cause the controller to: determine an engine soak time, in response to the engine soak time being greater than a threshold soak time, determine a battery state of charge (SOC) and comparing the battery SOC to a threshold SOC, activate an electric exhaust gas heater (eEGH) in response to the battery SOC being greater than the threshold SOC, and start an engine using a starter motor in response to an ambient temperature being less than a threshold ambient temperature. In a first example of the system, the battery is further configured to drive an electric motor. In a second example of the system, optionally including the first example, the instructions further cause the controller to start the engine using a starter generator in response to the ambient temperature being greater than or equal to the threshold ambient temperature. In a third example of the system, optionally including one or both of the first and second examples, the instructions further cause the controller to utilize electric energy generated while the vehicle is stationary to operate the eEGH or to increase the battery SOC. In a fourth example of the system, optionally including one or more or each of the first through third examples, the instructions further cause the controller to apply a negative torque to the engine while a vehicle is stationary. In a fifth example of the system, optionally including one or more or each of the first through fourth examples, the instructions further cause the controller to derate a power output of the engine relative to a driver demand and meeting a difference between the driver demand and the derated power output via an electric motor In a sixth example of the system, optionally including one or more or each of the first through fifth examples, the instructions further cause the controller to start the engine without the eEGH in response to the engine soak time being less than or equal to the threshold soak time.

The disclosure also provides support for a method including determining a battery state of charge (SOC) and comparing the battery SOC to a threshold SOC, activating an electric exhaust gas heater (cEGH) in response to the battery SOC being greater than the threshold SOC, and starting an engine using a starter generator in response to an ambient temperature being greater than or equal to a threshold ambient temperature during a cold-start of the engine. In a first example of the method, the method further comprises: applying a negative torque to the engine while a vehicle is stationary. In a second example of the method, optionally including the first example, the method further comprises: utilizing electric energy generated while the vehicle is stationary to operate the eEGH or to increase the battery SOC. In a third example of the method, optionally including one or both of the first and second examples, the method further comprises: maintaining a vehicle comprising the engine stationary while an aftertreatment device is heated via the cEGH and the engine. In a fourth example of the method, optionally including one or more or each of the first through third examples, the method further includes derating a power output of the engine while the vehicle is driven when an aftertreatment device is being heated via the eEGH and the engine.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method comprising:
in response to an engine soak time greater than a threshold soak time;
determining a battery state of charge (SOC) and comparing the battery SOC to a threshold SOC;
activating an electric exhaust gas heater (eEGH) in response to the battery SOC being greater than the threshold SOC; and
starting an engine using a starter generator in response to an ambient temperature being greater than or equal to a threshold ambient temperature.

2. The method of claim 1, further comprising starting the engine using a starter motor in response to the ambient temperature being less than the threshold ambient temperature.

3. The method of claim 1, further comprising activating an auxiliary fan for a threshold duration prior to starting the engine.

4. The method of claim 1, further comprising applying a negative torque to the engine while a vehicle is stationary.

5. The method of claim 4, further comprising utilizing electric energy generated while the vehicle is stationary to operate the eEGH or to increase the battery SOC.

6. The method of claim 4, further comprising utilizing electric energy generate while the vehicle is stationary to operate auxiliary electric loads of the vehicle.

7. The method of claim 1, wherein the starter generator increases an engine speed to a threshold engine speed.

8. The method of claim 1, further comprising derating a power output of the engine relative to a driver demand and meeting a difference between the driver demand and the derated power output via an electric motor.

9. A system, comprising:
an engine;
an integrated starter generator (BISG) coupled to the engine;
a starter motor coupled to the engine;
a battery configured to power each of the BISG and the starter motor; and
a controller with computer-readable instructions stored on non-transitory memory that when executed cause the controller to:
determine an engine soak time;
in response to the engine soak time being greater than a threshold soak time;
determine a state of charge (SOC) of the battery and compare the battery SOC to a threshold SOC;
activate an electric exhaust gas heater (eEGH) in response to the battery SOC being greater than the threshold SOC; and
start the engine using the starter motor in response to an ambient temperature being less than a threshold ambient temperature.

10. The system of claim 9, wherein the battery is further configured to drive an electric motor.

11. The system of claim 9, wherein the instructions further cause the controller to start the engine using a starter generator in response to the ambient temperature being greater than or equal to the threshold ambient temperature.

12. The system of claim 9, wherein the instructions further cause the controller to utilize electric energy generated while a vehicle comprising the engine is stationary to operate the eEGH or to increase the battery SOC.

13. The system of claim 9, wherein the instructions further cause the controller to apply a negative torque to the engine while a vehicle is stationary.

14. The system of claim 9, wherein the instructions further cause the controller to derate a power output of the engine relative to a driver demand and meeting a difference between the driver demand and the derated power output via an electric motor.

15. The system of claim 9, wherein the instructions further cause the controller to start the engine without the eEGH in response to the engine soak time being less than or equal to the threshold soak time.

16. A method, comprising:
determining a battery state of charge (SOC) and comparing the battery SOC to a threshold SOC;
activating an electric exhaust gas heater (eEGH) in response to the battery SOC being greater than the threshold SOC; and
starting an engine using a starter generator in response to an ambient temperature being greater than or equal to a threshold ambient temperature during a cold-start of the engine.

17. The method of claim 16, further comprising applying a negative torque to the engine while a vehicle is stationary.

18. The method of claim 17, further comprising utilizing electric energy generated while the vehicle is stationary to operate the eEGH or to increase the battery SOC.

19. The method of claim 16, further comprising maintaining a vehicle comprising the engine stationary while an aftertreatment device is heated via the eEGH and the engine.

20. The method of claim 16, further comprising derating a power output of the engine while a vehicle comprising the engine is driven when an aftertreatment device is being heated via the eEGH and the engine.
